(19) United States
(12) Patent Application Publication
(10) Pub. No.: US 2016/0339279 A1
(43) Pub. Date: Nov. 24, 2016

(54) UNKNOWN

(71) Applicant: Stoebich Brandschutz GmbH, Goslar (DE)

(72) Inventor: Christian HOLZ, Bad Harzburg (DE)

(21) Appl. No.: 15/159,990

(22) Filed: May 20, 2016

(30) Foreign Application Priority Data
May 21, 2015 (EP) 10 2015 108 074.5

(51) Int. Cl. A62C 2/10; E06B 9/08; E06B 5/16

(52) U.S. Cl. CPC A62C 2/10; E06B 5/162; E06B 9/08; E06B 2009/17053

(57) ABSTRACT

The invention relates to a smoke and/or fire protection curtain for the sealing of an opening (12), with a protective element (16) for preventing the spread of smoke or fire through the opening (12), the protective element (16) comprising a wicket door (18), which can be arranged in a slip position, in which it is possible to pass through the protective element (16), and a closed position, in which the spread of smoke or fire through the opening (12) is prevented, with the wicket door (18) forming a tunnel (20) in the slip position. According to the invention, a fixing device (48) is provided for the reversible fixing of a lower wicket door edge (23) when the wicket door (18) is in a closed position, the fixing device comprising at least one magnetic strip (94) for the smoke-proof sealing of the wicket door (18).

The invention relates to a smoke and/or fire protection curtain for the sealing of an opening in a building, with a protective element that comprises a wicket door, whereby the wicket door can be arranged in a slip position, in which it is possible to pass through the protective element.

Smoke or fire protection curtains of this sort are used to prevent the spread of smoke and/or a fire through an opening in a building. However, it is preferable if people who are in a part of a building that is on fire are able to escape through the fire protection curtain. So-called wicket doors are designed for this purpose.

The term ‘wicket door’ should be understood to mean a structure within the fire protection curtain that allows a person to get from one side of the fire protection curtain to the other. This does not refer to doors in the traditional sense of the word, as the affected structures of the fire protection curtain can only be moved to a certain degree relative to one another. In addition, the protective element is preferably made of a fire resistant material and is thus flexible, meaning that the wicket door is made of material that is often not dimensionally stable.

A fire protection curtain is described in JP 2001-17561, wherein part of the protective element forms a fire door. When the fire door is closed, the area of the fire resistant material that forms the wicket door lies flat on the part of the fire protection element that does not form part of the fire door. The edge of the fire door is fixed to a bottom bar and can be folded away in order to open the fire door. The disadvantage of this sort of system is that it is not smoke-proof. In addition, it is difficult for wheelchair users to get through this type of wicket door.

A wicket door in a fire protection curtain is described in U.S. Pat. No. 6,070,640 that is made up of overlapping strips of the protective element. This type of system is also not smoke-proof.

DE 10 2005 001 211 A1 describes a fire protection curtain with a wicket door which can be used by the fire brigade to open doors without it causing a massive spread of smoke through the open door. The publication describes that the lateral edges and the lower edge of the wicket door can be closed with a Velcro fastener. This sort of system is not suitable as a permanently installed smokeproof closure in a building.

The disadvantage of known fire protection curtains is that the wicket doors can be activated either only with considerable physical effort, which impairs escape, in particular for physically disabled people, especially those in a wheelchair, or they can indeed be opened easily, but do not have a sufficient protective effect against fire. This is especially true if a pressure difference forms between the two sides of the fire protection curtain.

An additional disadvantage of known wicket doors is that they reduce the fire or smoke resistant effect of the smoke or fire protection curtain. A wicket door must always be constructed such that it can move relative to the rest of the protective element. However, movable parts or sections make the sealing more difficult, particularly against smoke.

The invention aims to reduce the disadvantages of the prior art.

The invention solves the problem by means of a smoke or fire protection curtain with the features stated in claim 1. The smoke and/or fire protection curtain according to the preamble therefore features a fixing device for the reversible fixing of a lower wicket door edge, in particular onto the bottom bar, when the wicket door is in a closed position, the fixing device comprising at least one magnetic strip for the smoke-proof sealing of the wicket door.

The advantage of this sort of smoke and/or fire protection curtain is that it is smoke-proof.

An additional advantage is that the smoke and/or fire protection curtain according to the invention is easy to produce.

Within the scope of the present description, a fire and/or smoke protection curtain should be understood to mean in particular any device that is designed to prevent the spread of fires and/or smoke, or to obstruct it for a long period of time, or to prevent the spread of smoke produced by a fire. The smoke and/or fire protection curtain preferably complies with the EN 1634-3 test standard for smoke control and/or the UL 1784 US test standard.

The fire or smoke protection curtain is preferably designed to withstand a fire for at least 30 minutes, especially at least 60 minutes, preferably for at least 90 minutes, particularly preferably for at least 120 minutes. This test is conducted especially in accordance with DIN EN 1634-1 or DIN EN 13501-2 and 3 (each standard as of 1st May 2016). A fire or smoke protection device is thus inherently different to devices that are only suitable for the sealing of openings.

The protective element is preferably made of a fire resistant material. The protective element could also be called a smoke protection element or alternatively a smoke and/or fire protection element. This should be especially understood to mean that the fire resistant material is the integral component of the protective element. It is possible and represents a preferred embodiment that the fire resistant material contains non-material components, such as a lamination with a metal foil and/or a layer made of a material that reacts in an endothermic way under the influence of heat, for example by means of emitting steam. It is favourable if the protective element is flexible.

The term fire resistant material should be especially understood to mean a fabric, non-crimp fabric or knitted fabric that is not flammable and withstands thermal loads for a sufficiently long time to prevent an entrance of flames and/or smoke, especially for at least 30 minutes according to DIN EN 1634-1 (as of 1st May 2016). The advantage of using fire resistant materials is the low effort required to produce them. This means it is possible to make the protective element out of one, two, three or more flat pieces of fire resistant material by connecting them, especially by sewing them together.

In addition, the wicket door can be arranged in a closed position in which the protective element prevents an entrance through the opening.

The feature that the wicket door forms a tunnel when in the slip position should be especially understood to mean that the section of the protective element in which the wicket door is arranged extends away from the rest of the protective element and forms a curved tunnel, through which a person can get from one side of the protective element to the other.

The protective element can be put in a closed position in which the protective element seals the opening, and a compact storage position in which the protective element unblocks the opening. It is possible that the smoke and/or fire protection curtain comprises a winding shaft onto which the protective element is wound when in the storage position. This winding shaft can be moved, for example, by means of an electric winding shaft motor. Alternatively it is possible that the protective element is gathered together when in the storage position.

When in the sealing position, the protective element extends along a closing surface. This closing surface is preferably even. However, it is also possible for the closing surface to be curved in at least one dimension, meaning that it can be described as the lateral surface of a prismatic body. The closing surface preferably runs vertically from top to bottom. A two-dimensional curvature is also possible.

When in the slip position, the wicket door preferably forms a tunnel that is bordered by fire resistant material on at least three sides and that extends away from the closing surface. In particular, the protective element forms the tunnel that constitutes the wicket door. The protective element borders the tunnel at the top and at least partially at the sides. In order for a person to be able to get through the wicket door, the tunnel is opened towards the front. In addition, it is beneficial if the tunnel is open at the bottom. It is favourable if the bottom of the tunnel is not bordered by fire resistant material.

It is beneficial if the fire resistant material that borders the tunnel extends along the protective element when the wicket door is in the closed position. It is then easy to put the protective element in the storage position by winding it up.

It is possible and represents a preferred embodiment that the fire resistant material in the wicket door is the same as the fire resistant material in the body. This facilitates production.

The wicket door preferably comprises a folding section made of fire resistant material, which pivots upwards when opened. Of course, this does not refer to pivoting in the sense that a fixed body pivots on a linear pivot axis, as the folding section is made of fire resistant material. The term folding up could thus be used in place of pivoting. The term folding section should be especially understood to mean a part of the wicket door that borders the tunnel at the top when the wicket door is open.

It is favourable if the pivoting occurs on an imaginary pivot axis, which forms a maximum angle of 45°, in particular a maximum of 30°, with the horizontal. It is especially favourable if the angle that the imaginary pivot axis forms with the horizontal is as small as possible. Ideally the pivot axis runs approximately horizontal. This should be understood to mean that the folding section pivots upwards and not to the side. It is therefore favourable if the wicket door comprises a folding section which pivots upwards upon opening. When the wicket door is in the closed position, the folding section preferably reaches the floor, such that the smoke and/or fire protection curtain can be made to be smoke-proof.

It is possible and represents a preferred embodiment that the lateral sections and folding section are connected to each other in one piece. ‘In one piece’ means joint-free. Alternatively it is possible that the lateral sections and folding section are sections that are connected to one another, especially sewn together.

According to a preferred embodiment, when the wicket door is in the slip position it has a clearance height of at least 70 centimetres. This ensures that people of limited mobility can also pass through the wicket door. The clearance height should be understood in particular to mean the maximum height of a 30 centimetre wide and 100 centimetre deep cuboid that can pass the wicket door without damaging the protective element. It is beneficial if the clearance height is a maximum of 200 centimetres. The clearance height may be greater than 200 centimetres, but this will cause comparatively high material costs.

It is beneficial if the wicket door is placed at a distance from the lateral edges of the protective element. In other words, the wicket door does not border an edge of the fire resistant material. In other words again, the wicket door is located in a mid-section of the smoke or fire protection curtain. It is known to design lateral guides of the fire protection curtain in such a way that they can be folded away, thereby enabling people to pass through the smoke and/or fire protection curtain. However, the disadvantage of this sort of solution is that the guide tracks must be designed to be quite bulky, which is undesirable.

It is beneficial if the smoke and/or fire protection curtain comprises two, three or more wicket doors. This is especially advantageous with smoke or fire protection curtains which are at least 10 metres wide. If two, three or more wicket doors are available, it is beneficial if at least two of them extend in different directions in relation to the protective element. In other words, one wicket door extends to the side facing away from the fire and another wicket door extends to the side facing the fire.

The tunnel preferably extends at an angle of at least 45°, in particular at least 60° in relation to a body of the protective element. In other words, a tunnel extension direction runs at an angle of at least 45°, in particular at least 60°, in relation to a body of the protective element. The extension direction is determined by determining the cross-sections of the wicket door in planes parallel to the closing surface, the planes being at a distance of 10 centimetres from one another. The geometric centres of gravity of the cross-sections are then determined and the balance line identified by means of these centres of gravity. The balance line is the extension direction. The angle in relation to the body of the protective element is determined by identifying the tangent to the closing surface in the area of the wicket door and calculating the angle of the tangent with the balance line.

According to a preferred embodiment, the wicket door is designed such that, upon opening, a first part of the wicket door pivots along a first fold line between the wicket door and body, and upon opening, a second part of the wicket door pivots along a second fold line between the wicket door and body, with at least one fold line running inclined to the vertical. It is possible and represents a preferred embodiment that two fold lines run inclined to the vertical, in particular at the same angle. This allows the protective element to be easily wound up.

For example, the first part is the left lateral section and the second part is the right lateral section.

An angle of obliquity between the fold line and the vertical preferably lies between 30° and 60°.

It is especially possible and represents a preferred embodiment that the wicket door is bordered by precisely two fold lines.

It is beneficial if the wicket door in the closing surface has a triangular or square-shaped cross-section. A smoke and/or fire protection curtain with this type of wicket door is easy to produce.

The wicket door is preferably designed such that it can be opened with a maximum force of 80 Newton, in particular a maximum of 50 Newton. A force of this scale can generally be exerted by any person who is escaping, thereby largely excluding the possibility of a single person being unable to open the wicket door.

It is beneficial if the wicket door comprises a left lateral section, a right lateral section and the folding section, the lateral sections being folded and extending along the closing surface when the wicket door is in the closed position. The folded lateral sections enable the protective element to be easily put into the storage position, for example by winding it up on a winding shaft. In order to ease the rolling up process, it is advantageous if the lateral sections are fixed at their lower edge, namely the wicket door edge, to the area of the protective element that does not form the wicket door, but also that they are placed at a distance from the wicket door edge by means of magnetic strips.

If the wicket door is not in the slip position the lateral sections are unfolded. They preferably extend away from the body of the fire protection curtain. The body is the part of the fire protection curtain that does not form the wicket door. It is beneficial if the lateral sections are wedge-shaped when the wicket door is in the slip position.

According to a preferred embodiment, the wicket door is designed such that its lower wicket door edge is at the same height as a body edge of the remaining protective element when the wicket door is in the closed position. This means that the wicket door does not create any gaps, meaning that the smoke and/or fire protection curtain can be sealed at the bottom so that it is smoke-proof.

It is especially favourable if the wicket door has two lateral sections that are folded in a Z-shape or in the shape of a zigzag. In other words, the wicket door preferably has a section on both sides that is situated above the folding section when the wicket door is in the closed position, and an additional section that lies above the body of the protective element. The lateral sections are those sections of the wicket door that border the tunnel along the side.

When the wicket door is in the slip position, the folding section preferably extends along a folding surface which is tilted downwards at a maximum of 35° to the horizontal plane. It is more beneficial if the folding surface is tilted downwards at a smaller angle. However, it is also theoretically conceivable that the folding surface is inclined upwards at an angle, but this generally does not create any additional advantage. If the angle to the horizontal is precisely 0° then the folding surface runs horizontally when the wicket door is in the slip position.

The smoke and/or fire protection curtain comprises a fixing device by means of which the lower wicket door edge is fixed when the wicket door is in the closed position. The fixing device has a magnetic strip for the smoke-proof sealing of the wicket door. The magnetic strip is magnetised and can be fixed to the protective element and interacts with a ferromagnetic counter element. The ferromagnetic counter element can be magnetised, i.e. have a remanent magnetic field, or it can be unmagnetised.

According to a preferred embodiment, the smoke and/or fire protection curtain comprises a bottom bar that is arranged on a lower edge of the protective element, and a ferromagnetic strip is arranged on the bottom bar, which forms a smoke-proof connection with the magnetic strip when the wicket door is in the slip position.

The ferromagnetic strip is preferably flexible and protrudes upwards from the bottom bar. It is then possible for a wheelchair user to roll over the bottom bar, thereby separating the connection between the magnetic strip and the ferromagnetic strip and opening the wicket door, the ferromagnetic strip being pushed away when it is rolled over and raising itself once again after it has been rolled over. This allows the wicket door to be closed so that it is once again smoke-proof after the wheelchair user has passed through it. In other words, the ferromagnetic strip is so elastic that, following a distortion, especially when rolled over by a wheelchair, it can move itself back into a position in which the ferromagnetic strip and the magnetic strip can once again close the wicket door so that it is rendered smoke-proof.

The ferromagnetic strip may refer to a second magnetic strip that is arranged such that the first magnetic strip and the second magnetic strip attract each other, thereby closing the wicket door so that it is smoke-proof.

The bottom bar is preferably continuous. This means that it extends from the left guide track to the right guide track and is made to be rigid. In particular, the bottom bar does not have any joints and cannot be reversibly separated.

When the wicket door is in the closed position, the magnetic strip preferably interacts with a counter element, especially the ferromagnetic strip, the magnetic strip and the counter element sticking reversibly to one another. This should be understood to mean that the magnetic strip and the counter element also stick to one another when the magnetic element is demagnetised. In particular, the magnetic strip and/or the counter element has a reversibly sticking surface. A reversibly sticking surface should be understood to mean a surface from which the object stuck to it can be removed and re-stuck to it. This principle is known from Post-it notes, for example, which can be stuck to and removed from an object several times over.

Due to the fact that the magnetic strip and the counter element can be reversibly stuck to one another, the connection between the two is stronger than a purely magnetic connection. In particular, the magnetic strip and the counter element cannot slide over one another if a tractive force is exerted on them. The effect of this is that the wicket door also remains closed and smoke-proof when a pressure difference is acting on the protective element.

The surface of the magnetic strip and/or the counter element preferably comprises an adhesive. This may refer to a dispersion adhesive, such as an acrylate adhesive. This coating is permanently elastic and non-hardening.

The wicket door is preferably folded, especially in a Z-shape, and forms an overlap in the area of the bottom bar, the protective element in the area of the overlap comprising at least one magnetic strip, which connects parts of the protective element facing each other so that it is rendered smoke-proof. This magnetic strip preferably runs parallel to the bottom bar, especially at the height of the bottom bar. In order to ensure that it is smoke-proof, the at least one magnetic strip is particularly arranged such that all layers of the lower edge of the wicket door are magnetically connected with the neighbouring layer so that they are smoke-proof.

The smoke and/or fire protection device preferably has a bottom bar that is arranged on a lower edge of the protective element and has a first height in the area of the wicket door and, at a distance from the area of the wicket door, a second height which is greater than the first. A higher bottom bar has a greater bending stiffness, which is advantageous. In order to facilitate passing through the wicket door, particularly for wheelchair users, the bottom bar has a lower height in the area of the wicket door.

For example, the first height is a maximum of 2 centimetres, especially a maximum of 1.5 centimetres. This facilitates the crossing or rolling over of this area of the bottom bar. It is beneficial if the second height is at least 4 centimetres, which ensures a greater bending stiffness.

The parts of the wicket door that must move upon opening can be connected by means of a connection with the body of the protective element that irreversibly disconnects itself. In this way it is possible and represents a preferred embodiment that the wicket door is connected to the body by means of a connecting element, which gives slightly under a peel load, for example it comprises a perforation. A person who is escaping can gently disrupt the connecting element and thereby open the wicket door.

According to a preferred embodiment, the fixing device comprises a seam by means of which the wicket door is fixed relative to the body of the protective element and which is not thermally stable, and an electric heating device, in particular a heating wire, that is arranged such that the seam can be thermally destroyed by the activation of the heating device. In the event of a fire, the seam can be destroyed in this way and the wicket door can be rendered passable.

Independent subject-matter of the present application is also a smoke and/or fire protection curtain with a protective element, especially made of fire resistant material, which comprises a fixing device, the fixing device comprising a seam by means of which one part of the protective element, in particular a wicket door, is connected to another part of the protective element, whereby the seam is not thermally stable and the fixing device comprises an electric heating device, especially a heating wire, which is arranged such that the seam can be thermally destroyed by the activation of the heating device. The wicket door is preferably fixed relative to the body of the protective element by means of the fixing device.

The heating device is preferably at least fixed to the fire resistant material in sections.

The preferred features of the smoke and/or fire protection curtain, as presented in this description, are also preferred features of this invention.

It is favourable if the wicket door is smoke-proof when in the closed position. In other words, the smoke and/or fire protection curtain is itself smoke-proof. The level of smoke control is measured in accordance with EN 1634-3 and/or the US test standard UL 1784.

It is beneficial if the protective element comprises a first web made of fire resistant material, a second web made of fire resistant material and a third web made of fire resistant material, the lateral sections being single pieces of at least one web. In this way, the protective element can be produced with few seams. For example, it is possible that the webs run vertically. The concept of running vertically should be understood to mean that, strictly speaking, the web can indeed run at an angle of 0° to the perpendicular, but it is not necessary. For example, a deviation of 5° is possible.

Alternatively it is possible that the lateral sections are also used as inserts, especially sewn-in inserts, between two webs made of fire resistant material.

According to a preferred embodiment, the smoke and/or fire protection curtain comprises a bottom bar that has a first bottom bar section, a second bottom bar section and a third bottom bar section, the second bottom bar section being arranged between the first and the third bottom bar section and being connected such that the connection can be dissolved, and the second bottom bar being connected to the wicket door, especially to the folding section. In particular, the folding section is only connected to the second bottom bar section. In order to ease the opening of the wicket door, if they are available, the lateral sections of the wicket door are not connected to any bottom bar section. It is then possible to open the wicket door by taking hold of the second bottom bar and moving it away from the other two bottom bars. The bottom bar to which the folding section is fixed preferably has a handle.

It is beneficial if the bottom bar sections are designed to be rigid in terms of a bending movement in the plane of the closing surface. In this way the bottom bar can absorb and transfer any tensions in the protective element that result from a possible winding up of the protective element, which leads to less folds.

It is beneficial if the second bottom bar section can be detached from the first and third bottom bar section by moving it perpendicular to the closing surface. However, it is also possible that the bottom bar section on which the wicket door, especially the folding section, is fixed can be detached relative to the adjacent bottom bar sections in terms of any movement perpendicular to a longitudinal direction of the bottom bar section.

For example, the bottom bar sections are connected to each other by means of magnets and/or by a positive-locking connection. Alternatively or in addition to this, the bottom bar section on which the wicket door is fixed, is connected to an adjacent bottom bar section by means of adhesive strips.

According to a preferred embodiment, the bottom bar comprises a locking device that is thermally activated and designed such that, if a predetermined activation temperature is exceeded, the first bottom bar section and the second bottom bar section are securely connected to one another. The second and third bottom bar sections—if available—can also preferably be connected to one another using the connecting device.

Furthermore, the invention includes a building with a wall with an opening and a smoke and/or fire protection curtain according to the invention, which is arranged for the reversible sealing of the opening.

In the following, the invention will be explained in more detail in the attached drawings. They show

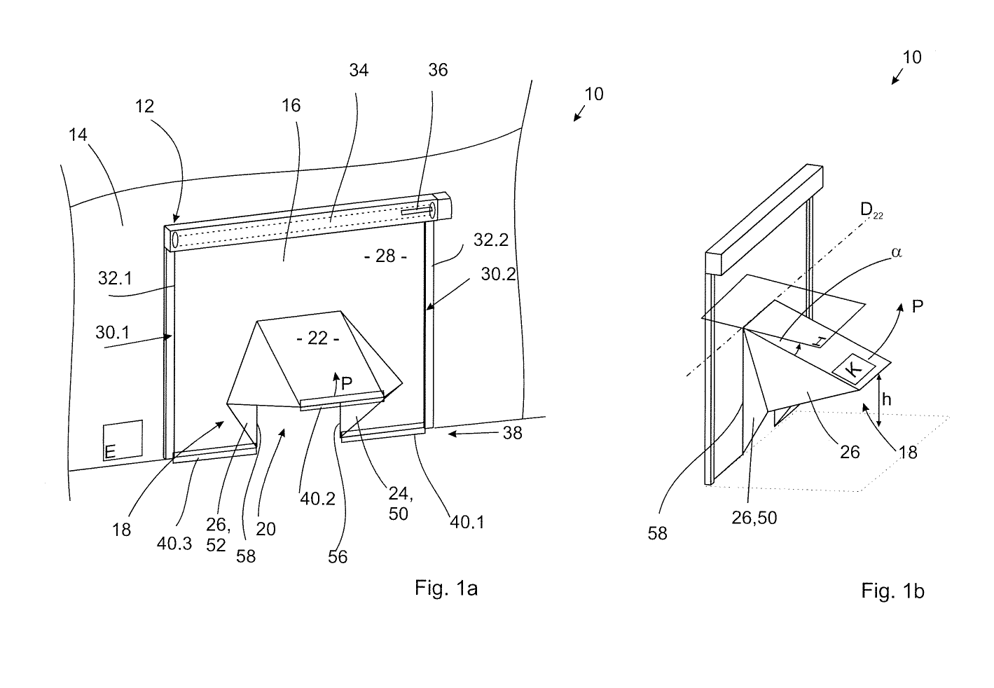

FIG. 1a a schematic drawing of a smoke or fire protection curtain according to the invention with a half-opened wicket door in a perspective view,

FIG. 1b the smoke and/or fire protection curtain according to FIG. 1a in a second view,

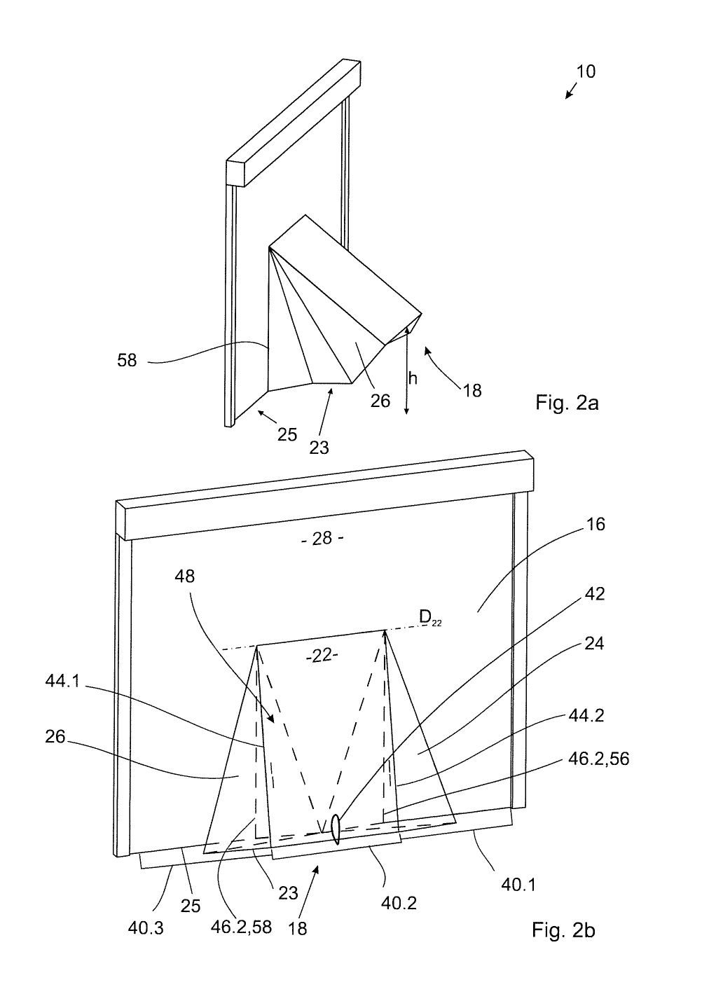

FIG. 2a a second embodiment of a smoke or fire protection curtain according to the invention with an opened wicket door in a perspective view,

FIG. 2b the smoke and/or fire protection curtain according to FIG. 2a with a closed wicket door,

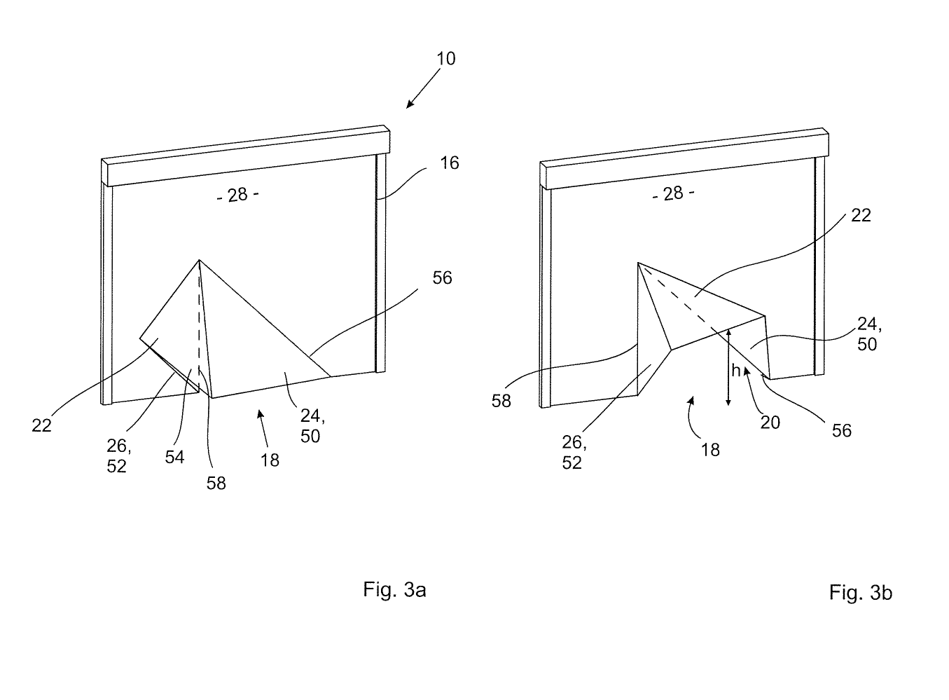

FIG. 3a depicts a perspective, schematic drawing of a smoke and/or fire protection curtain according to the invention according to a third embodiment with a closed wicket door,

FIG. 3b the smoke and/or fire protection curtain with an opened wicket door,

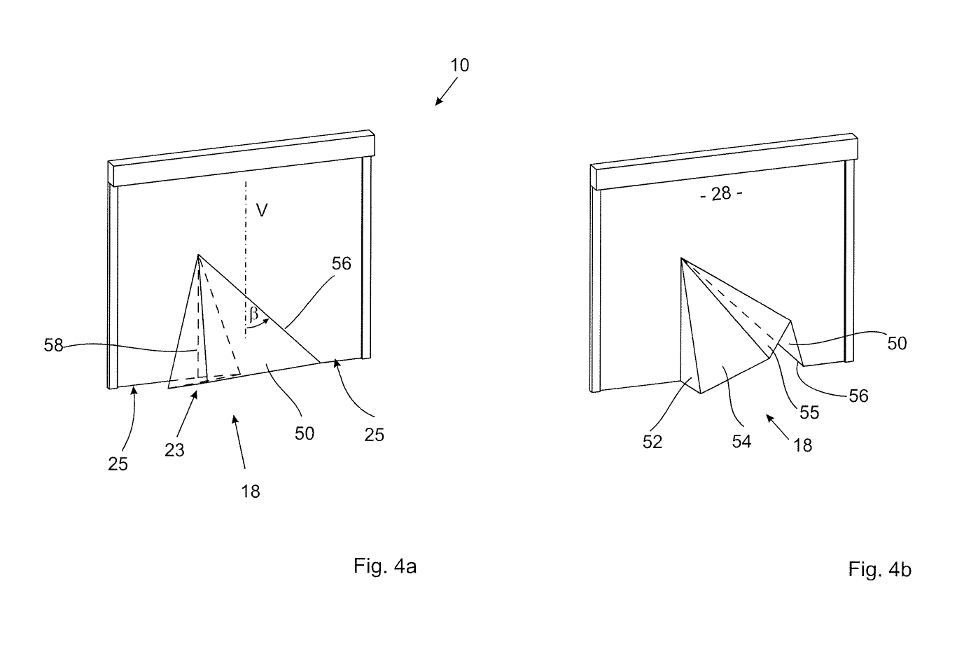

FIG. 4a a schematic drawing of a further smoke and/or fire protection curtain according to the invention with a closed wicket door,

FIG. 4b the smoke and/or fire protection curtain according to FIG. 4a with an open wicket door,

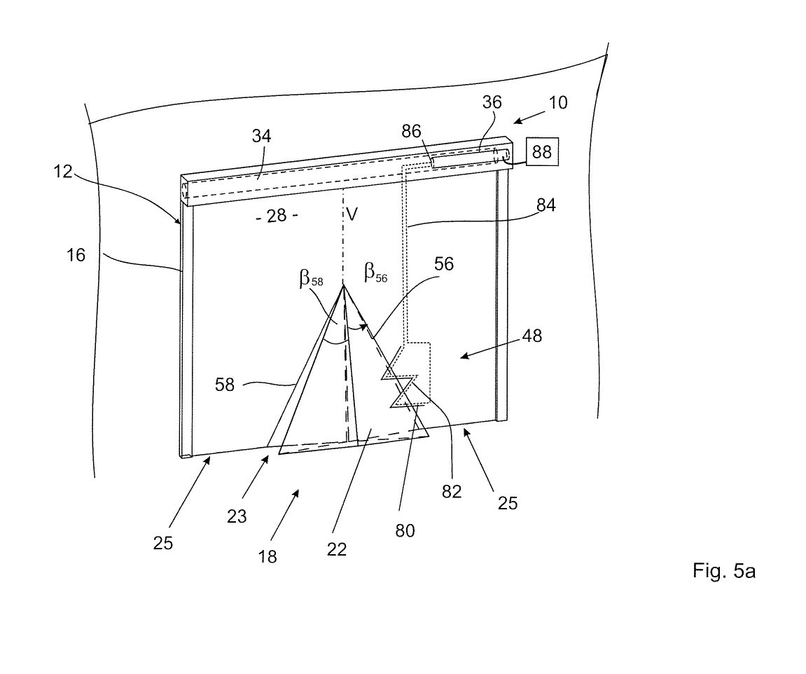

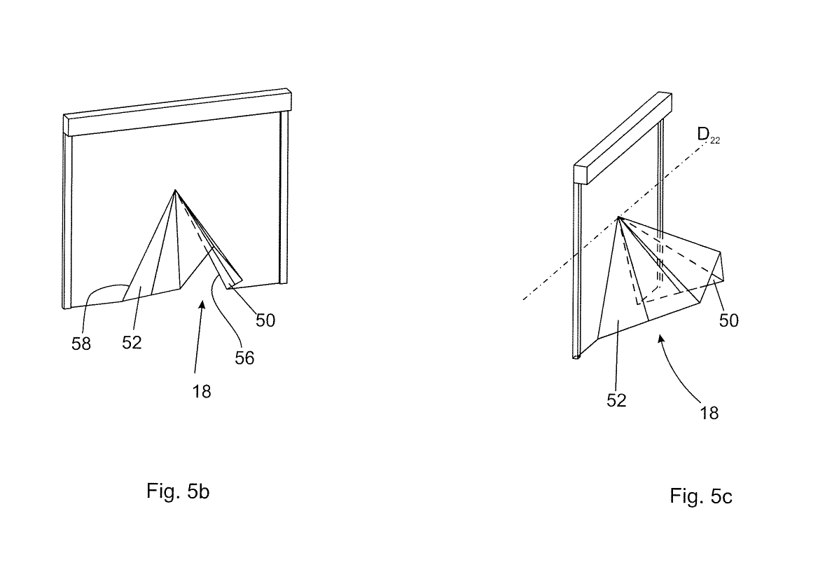

FIG. 5a a further embodiment of a smoke and/or fire protection curtain according to the invention with a closed wicket door,

FIG. 5b the smoke and/or fire protection curtain according to FIG. 5a in a half-opened position,

FIG. 5c the smoke or fire protection curtain with an opened wicket door,

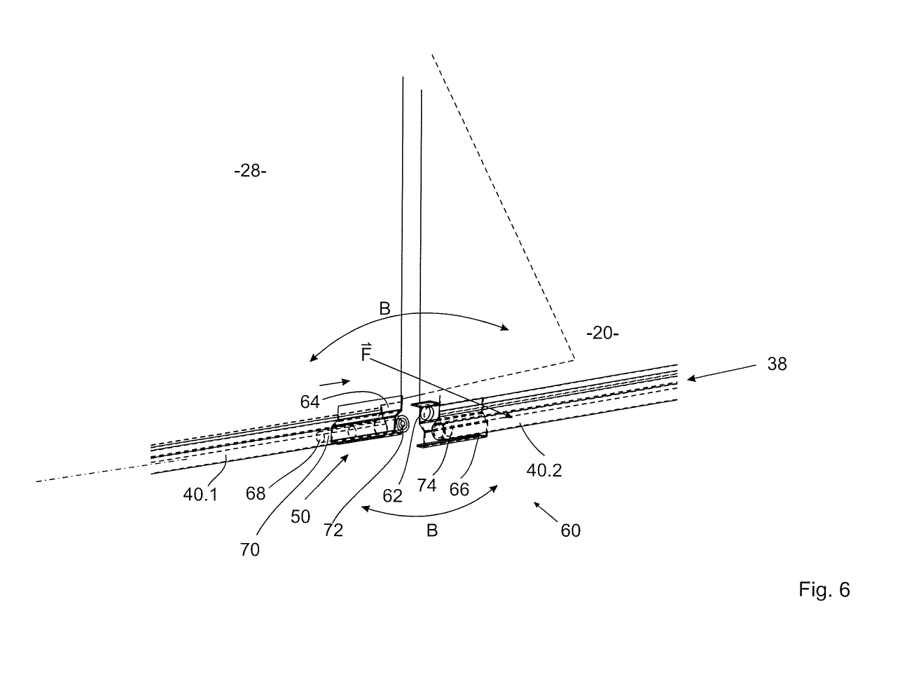

FIG. 6 a bottom bar of a smoke or fire protection curtain according to the invention. The

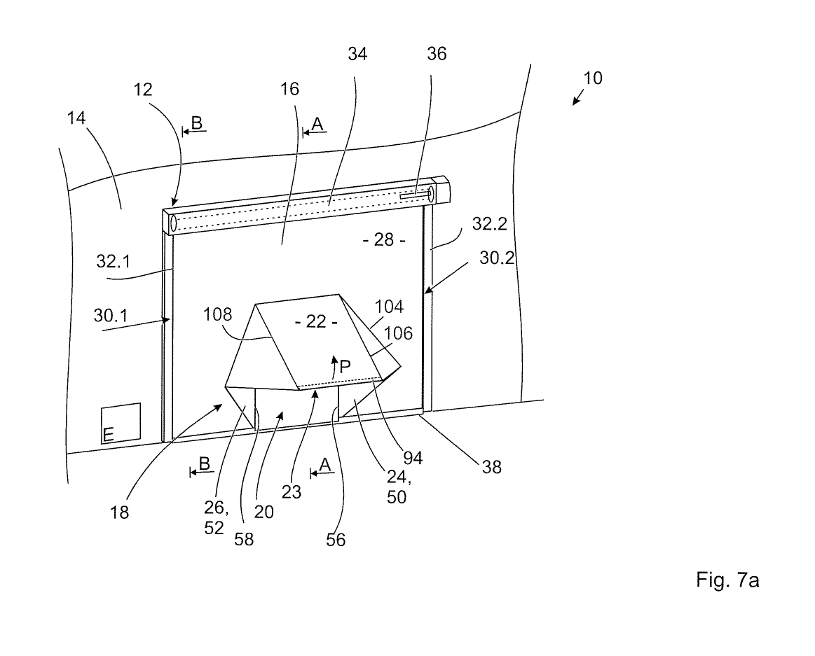

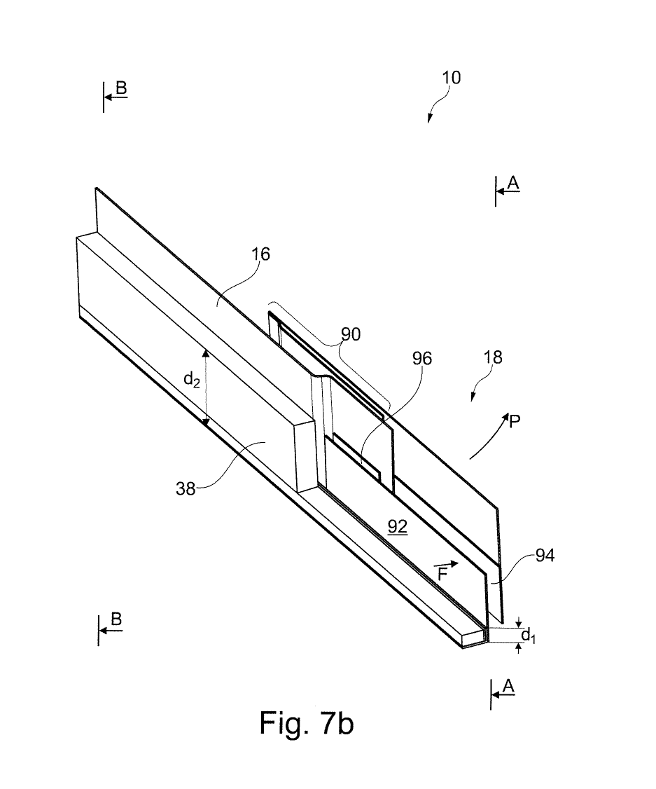

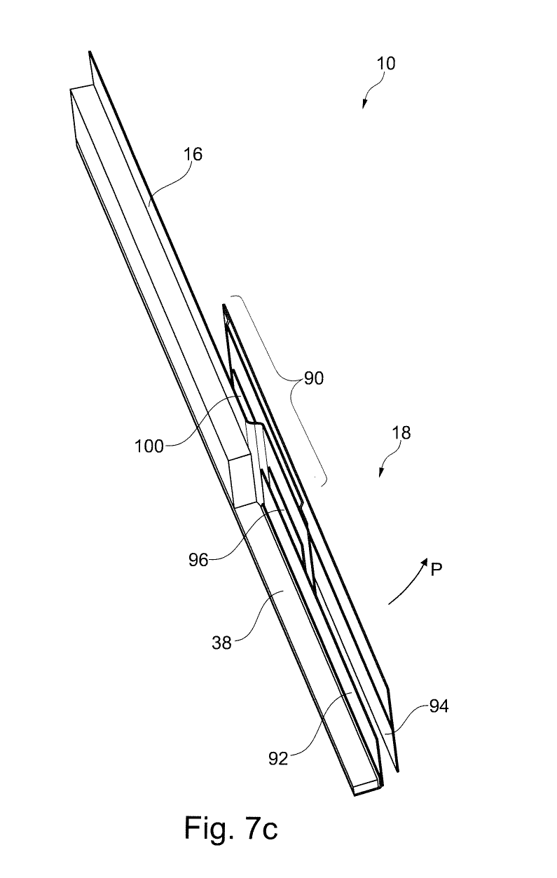

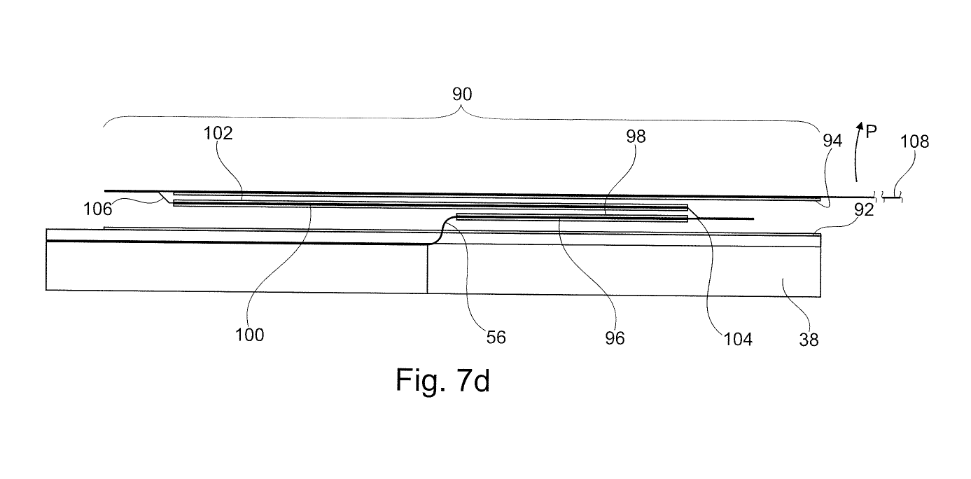

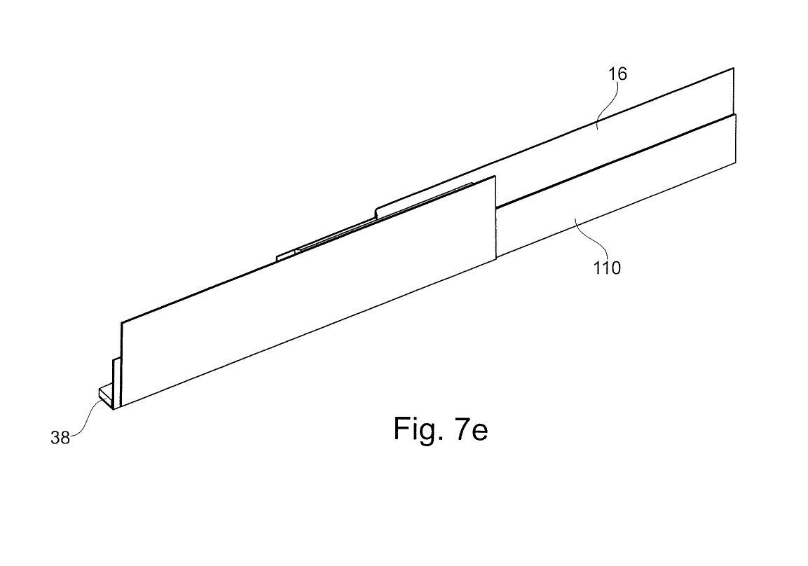

FIGS. 7a to 7e depict various three dimensional partial views of an especially smoke-proof embodiment of a smoke or fire protection curtain according to the invention.

FIG. 1a depicts a smoke and/or fire protection curtain 10 in the form of a smoke-proof fire protection curtain, which is arranged in an opening 12 of the wall of a building 14 for the sealing of the opening 12. The wall of the building 14 belongs to a building according to the invention which comprises a smoke and/or fire protection curtain according to the invention.

The smoke and/or fire protection curtain 12 has a protective element 16 made of fire resistant material, for example a woven fabric made of glass fibres and wire, such as stainless steel wire.

The protective element 16 comprises a wicket door 18. FIG. 1a depicts the protective element 16 in its closed position, in which the opening 12 is closed. It is possible to get from one side of the smoke or fire protection curtain 10 to the other by opening the wicket door 18.

The protective element 16 extends along a closing surface E, which in the present case is a vertically running plane. As depicted in FIG. 1a, when in its slip position shown in FIG. 1a the wicket door forms a tunnel 20, which is bordered by fire resistant material of the protective element 16 on the left, right and above. The tunnel 20 extends away from the closing surface E, meaning that a person who is escaping can get through the tunnel 20 by means of a movement along the perpendicular on the closing surface E.

The wicket door 18 comprises a folding section 22 that moves upwards in a pivoting motion when the wicket door 18 is opened, as indicated by the arrow P. The wicket door 18 comprises a left lateral section 24 and a right lateral section 26, which are both connected to the folding section 22 and a body 28 of the protective element 16. The body 28, the lateral sections 24, 26 and the folding section 22 form the protective element 16.

FIG. 1a shows that the wicket door 18 is arranged at a distance from the lateral edges 30.1, 30.2. The edges 30.1, 30.2 are guided into lateral guide tracks 32.1, 32.2. The protective element 16 can be put in a compact storage position by winding it up on a winding shaft 34 that is driven by an electric winding shaft motor 36.

The smoke and/or fire protection curtain 10 comprises a bottom bar 38, which comprises a first bottom bar section 40.1, a second bottom bar section 40.2 and a third bottom bar section 40.3. The folding section 22 is only fixed to the second bottom bar section 40.2. The body 28 is fixed to the first bottom bar section 40.1 and to the third bottom bar section 40.3. If the wicket door 18 is opened, the second bottom bar 40.2 moves away from the other two bottom bar sections 40.1, 40.3.

FIG. 1b depicts the smoke and/or fire protection curtain 10 in an additional perspective view. It should be recognised that the right lateral section 26 unfolds when the wicket door 18 is opened. A folding surface K, which is even in the present case and along which the folding surface 22 extends, forms an angle of inclination α with the horizontal plane H. If the folding section 22 tilts downwards, the angle of inclination is negative. In the present case the angle of inclination is α=−10°. The folding surface K is therefore tilted downwards by 15°. If the wicket door is completely open, the angle of inclination is greater than −15°, in the present case it is α=0°.

FIG. 1b shows that, when the wicket door 18 is opened, the folding section 22 pivots on an axis of rotation D₂₂, which runs horizontally in the present case.

It should be noted that, when in the position depicted in FIG. 1b, the wicket door 18 has a clearance height h, which is 90 cm in the present case.

FIG. 2a depicts an alternative embodiment of a smoke and/or fire protection curtain 10 according to the invention with the wicket door designed such that its lower wicket door edge 23 is at the same height as a body edge 25 of the remaining protective element when the wicket door 18 is in the closed position, which can be seen in FIG. 2b. In the present case the wicket door edge 23 and the body edge 25 are placed so low that essentially no smoke can get through.

FIG. 2b shows that the two lateral sections 24, 26 are folded in a Z-shape. In this state, one part of the lateral sections 24, 26 is positioned above the folding section 22 and another part is above the body 28.

FIG. 2b depicts the protective element 16, whose wicket door 18 is in the sealing position. The bottom bar sections 40.1, 40.2, 40.3 are joined to one another and are connected, for example, by means of magnets. The protective element 16 seals the opening 12 (see FIG. 1a) in this state so that it is rendered smoke-proof. The edges of the lateral sections 24, 26 are depicted by the dotted lines. It should be recognised that the lateral sections 24, 26 are folded when the wicket door 18 is in the sealing position.

The smoke and/or fire protection curtain 10 comprises a handle 42 by means of which the wicket door 18 can be opened. In the present case the handle 42 is fixed to the bottom bar 40.2, which is connected to the folding section 22. By exerting a maximum force of 50 Newton on the handle 42 the wicket door 18 can be opened.

A smoke and/or fire protection curtain 10 according to the invention can be produced, for example, by initially slitting the protective element 16 such that lateral edges 44.1, 44.2 of the folding section 22 form. The left lateral section 24 is then connected to the lateral edge 24.2 and an edge 46.2 of the body 28, for example by sewing them together. The right lateral section 26 is connected on one side to the edge 44.1, as well as with an edge 46.2 of the body 28.

It is possible and represents a preferred embodiment that the parts of the wicket door that are folded when the wicket door is in the sealing position have folding aids, such as metal wires.

FIG. 2b shows a schematic depiction of a fixing device 48 made up of Velcro strips. This allows the lateral sections 24, 26 to be fixed relative to the folding section 22 and the body 28 and ensures that they do not warp relative to one another when the protective element 16 is rolled up on the winding shaft 34 (see FIG. 1a).

The depicted smoke and fire protection curtain complies with the E120 fire protection classification.

FIG. 3a shows a further smoke-proof fire protection curtain 10 according to the invention with the wicket door 8 being formed by a first part 50, a second part 52 and a third part 54. In the slip position depicted in FIG. 3b, the parts 50, 52 border the tunnel 20 on the left and the right. The part 54 borders the tunnel 20 at the top.

It should be recognised that the first part 50 is separated from the body 28 of the protective element 16 by a first fold line 56. The second part 52 is separated from the body 28 by a second fold line 58. In general, the first fold line 56 describes the fold line between the body 28 and the left part of the wicket door 18, which may also refer to the left lateral section 24 (see FIG. 1a, 2b). Correspondingly, the second fold line 58 refers to the fold line between the body 28 and the right part of the wicket door 18, wherein this part may also refer to a right lateral section 26 (see FIG. 1a to 2b).

FIG. 3b shows the wicket door in the slip position.

FIG. 4a depicts a further embodiment of a smoke and/or fire protection curtain 10 according to the invention, with the wicket door 18 being made up of four parts 50, 52, 54, 55 of fire resistant material. It should be recognised that the first fold line 56 runs at an incline to the vertical V. In the present case an angle of obliquity β is β=45°. For the embodiment according to FIGS. 1a and 1b, as well as 2a and 2b, the angle of obliquity is β=0°.

FIG. 4b depicts the wicket door 18 in a position between the closed position and slip position.

FIG. 5a depicts a further embodiment of a smoke and/or fire protection curtain according to the invention in the form of a smoke-proof fire curtain 10, with the two fold lines 56, 58 of the wicket door 18 running at an incline to the vertical V. The angle of obliquity β₅₈ between the first fold line 56 and the vertical V, as well as the angle of obliquity β₅₈ between the second fold line 58 and the vertical V are equal in size and are 40° in the present case.

FIG. 5c shows the wicket door 18 in the slip position. FIG. 5b depicts the wicket door 18 between the slip position and the closed position.

FIG. 6 shows a bottom bar 38, which comprises a connecting device 60 that comprises a magnet 62—this represents a preferred arrangement. If the first bottom bar section 40.1 comes sufficiently close to the second bottom bar section 40.2 of the bottom bar 38, the magnet 62 attracts a ferromagnetic counter piece 64, resulting in the two bottom bar sections 40.1, 40.2 becoming fixed relative to one another.

One of the two bottom bar sections—in the present case, the second bottom bar section 40.2—has a coupling structure 66 that interacts with the opposite end of the adjacent bottom bar section—in the present case, the bottom bar section 40.1—such that the two bottom bar sections 40.1, 40.2 are positively connected to one another in a vertical plane E with regards to a bend B. The bend B is the bend that occurs when one of the two bottom bar sections pulls upwards more strongly than the other. The vertical plane is the plane in which the sections, to which the bottom bar sections are fixed, extend.

It should be recognised that the bottom bar 38 also comprises a locking device 68 by means of which the two bottom bar sections 40.1, 40.2 can be permanently connected to one another such that they can no longer be separated by exerting the pushing force F.

In the present case, the locking device 68 comprises a drive element 70 made of intumescent material, which expands in the event of a fire. The drive element 70 then pushes out a locking bar 72 out of the neutral position depicted in FIG. 6 such that it interlocks with a latch 74 in the opposite bottom bar section.

The locking device 68 ensures that, in the event of a fire, at the point when the heat from the fire has become so strong that the survival of people in the affected fire area can no longer be expected, the bottom bar is at its maximum bending strength in all directions. The divided bottom bar with the locking device thereby initially allows for an easy escape and later guarantees a high resistance of the fire protection curtain and therefore a high fire-resistant effect.

FIG. 5a also shows the fixing device 48, which comprises a seam 80 that is not thermally stable. For example, the seam 80 is produced using a seam material made of plastic, such as a polyamide. The seam 80 fixes the wicket door 18 relative to the body. The seam 80 also fixes a heating device 82—a heating wire in the present case—to the folding section 22 or to the body 28. The heating device 82 is connected to a power source 86 by means of a connection lead 84. The power source 86 may constitute part of the winding shaft motor 36 that drives the winding shaft 34.

The winding shaft motor 36 and the heating device 82 are connected to a control device 88. If the control device 88 receives the signal that there is a case of emergency, the control device 88 drives the winding shaft motor 36 such that the protective element 16 closes the opening 12. In addition, the control device 88 activates the heating device 82. This causes such a high temperature, at least in the vicinity of the seam 80, that the seam 80 is destroyed. As a result, the folding section 22 releases itself from the body 28 and the wicket door can be easily opened.

FIG. 7a depicts a schematic, perspective view of a smoke-proof smoke and/or fire protection curtain 10 according to the invention whereby the bottom bar 38 is designed to be continuous. In other words, it extends from the left guide track 32.1 to the right guide track 32.2 and is made of a single piece in the present case. However, this is not necessary. It is also possible that the bottom bar is made up of several parts that are joined rigidly to one another. In particular, the bottom bar 38 does not have any joints.

FIG. 7b schematically depicts the part between the sections A-A and B-B, wherein the protective element 16 is shown cut along a horizontal plane. FIG. 1b is a sectional view of a further smoke and/or fire protection curtain 10 according to the invention whose protective element 16 forms an overlap 90.

It should be recognised that the bottom bar 38 in the area of the wicket door 18 has a first height d₁ and, at a distance from the area of the wicket door 18, a second height d₂, which is greater than the first height d₁. In the present case, the first height d₁ lies between 10 and 18 millimetres, for example 12 millimetres. The second height d₂ is from 60 to 80 millimetres, for example 70 millimetres.

A ferromagnetic strip 92 is fixed to the bottom bar 38 in the area of the wicket door 18. A magnetic strip 94, which magnetically attracts the ferromagnetic strip 92, is fixed to the lower edge, i.e. the wicket door edge 23, of the part of the protective element 16 that forms the wicket door 18. In the present case, the ferromagnetic strip 92 is magnetised, like the magnetic strip 94, and arranged in opposite polarity to the magnetic strip 94, causing the two strips 92, 94 to attract each other. A smoke-proof seal forms as a result. For the sake of clarity, in FIG. 7b the two strips 92, 94 are depicted with a small distance between them; however, this distance is not present when using the smoke and/or fire protection curtain. The ferromagnetic strip 92 is thus the counter element to the magnetic strip 94, the two together sealing the wicket door 18 at its lower edge, namely the wicket door edge 23, so that it is smoke-proof.

The bottom bar 38 is made of steel. The ferromagnetic strip 92 is flexible, which means that a schematically depicted force F, which acts on the upper edge of the ferromagnetic strip 92, causes a reversible bending of the strip 92. As soon as the force 92 subsides, the strip 92 bends back into the position shown in FIG. 7b.

FIG. 7b also shows that a second magnetic strip 96 is fixed to the protective element 16 in the area of the overlap 90, the magnetic strip also interacting with the ferromagnetic strip 92 and connecting the protective element 16 with the bottom bar so that it is smoke-proof. The wicket door 18 is arranged in mirror-image symmetry in relation to the section plane A-A (see FIG. 7a). FIG. 7b depicts a view that corresponds to the view from the back at the paper plane according to FIG. 7a.

FIG. 7c shows a view from a higher position of the part of the smoke and/or fire protection curtain 10 according to FIG. 7b.

FIG. 7d depicts a horizontal cross section through the part according to FIGS. 7b and 7c. It should be recognised that a third magnetic strip 98, a fourth magnetic strip 100 and a fifth magnetic strip 102 are fixed on the protective element 16 in the area of the overlap 90. The magnetic strips 92, 96, 98, 100, 102, 94 are arranged such that the parts of the protective element 16 that lie opposite one another are connected so that they are rendered smoke-proof.

In this way, the protective element 16 in a wicket door edge 23 in a section between the first fold line 56 and a third fold line or seam 104 is connected with the bottom bar 38 so as to be rendered smoke-proof by the formation of a smoke-proof connection between the ferromagnetic strip 92 and the second magnetic strip 96. In the part between the third fold line or seam 104 and a fourth fold line 106, the fourth magnetic strip 100 and the third magnetic strip 98 connect the corresponding parts of the protective element 16 with one another so that they rendered smoke-proof. Between the fourth fold line or seam 106 and a fifth fold line 108, the magnetic strips 94 and 102 connect the corresponding parts to one another so that they are rendered smoke-proof.

It should be noted that not all of the magnetic strips shown in FIG. 7d are necessary. It is possible to replace some of the magnetic strips with strips made of ferromagnetic, yet unmagnetised, material. However, due to the greater holding force it is preferable to use only magnetic strips.

FIG. 7e shows a view from the back in which a metal sheet 110 can be seen, by means of which the protective element 16 is fixed to the bottom bar 38.

### REFERENCE LIST

10 smoke and/or fire protection curtain
12 opening
14 building wall
16 protective element
18 wicket door
20 tunnel
22 folding section
23 wicket door edge
24 left lateral section
25 body edge
26 right lateral section
28 body
30 edge
32 guide track
34 winding shaft
36 winding shaft motor
38 bottom bar
40 bottom bar section
42 handle
44 lateral end
46 edge
48 fixing device
50 first part
52 second part
54 third part
55 fourth part
56 first fold line
58 second fold line
60 connecting device
62 magnet
64 counter part
66 coupling structure
68 locking device
70 drive element
72 locking bar
74 latch
80 seam
82 heating device
84 connection lead
86 power source
88 control device
90 overlap
92 ferromagnetic strip
94 magnetic strip
96 second magnetic strip
98 third magnetic strip
100 fourth magnetic strip
102 fifth magnetic strip
104 third fold line
106 fourth fold line
108 fifth fold line
110 metal sheet
α angle of inclination
β angle of obliquity
D₂₂ rotational axis
E closing surface
h clearance height
H horizontal plane
K folding surface
P arrow
V vertical
d height
F force

1. Smoke and/or fire protection curtain for the sealing of an opening, comprising:
(a) a protective element for preventing or reducing the spread of smoke or fire through the opening,
(b) wherein the protective element includes a wicket door, which is configurable
in a slip position, in which it is possible to pass through the protective element, and
in a closed position, in which the spread of smoke or fire through the opening is prevented or reduced,
wherein the wicket door, when in the slip position, forming a tunnel; and
(d) a fixing device for reversible fixing of a lower wicket door edge when the wicket door is in the closed position,
(e) wherein the fixing device includes at least one magnetic strip for the smoke-proof sealing of the wicket door.

2. Smoke and/or fire protection curtain according to claim 1, wherein the magnetic strip is flexible.

3. Smoke and/or fire protection curtain according to claim 1, further comprising
a bottom bar arranged on a lower edge of the protective element; and
a ferromagnetic strip fixed to the bottom bar,
wherein the at least one magnetic strip forms a smoke-proof connection with the ferromagnetic strip when the wicket door (18) is in the closed position, and
wherein the ferromagnetic strip is flexible and protrudes upwards from the bottom bar.

4. Smoke and/or fire protection curtain according to claim 1, wherein by the fact that
the at least one magnetic strip interacts with a counter element when the wicket door is in the closed position, and
the at least one magnetic strip and the counter element stick reversibly to one another.

5. Smoke and/or fire protection curtain according to claim 4, wherein a surface of the at least one magnetic strip comprises adhesive material.

6. Smoke and/or fire protection curtain according to claim 1, wherein
the wicket door is folded and forms an overlap in an area of a bottom bar the base board (38), and that
the at least one magnetic strip is arranged on the protective element in an area of the overlap with the at least one magnetic strip connecting opposite parts of the protective element with one another so they are rendered smoke-proof.

7. Smoke and/or fire protection curtain according to claim 1, further comprising a bottom bar that
is arranged on a lower edge of the protective element,
has a first height (d1) in an area of the wicket door, and
at a distance from the area of the wicket door, a second height (d2), which is greater than the first height (d1).

8. Smoke and/or fire protection curtain according to claim 1, wherein
the protective element is moveable into a sealing position in which the protective element closes the opening, and is moveable into a compact storage position in which the protective element unblocks the opening,
when the protective element is in the closed position, the protective element extends along a closing surface (E) and
the wicket door, when in the slip position, forms a tunnel that is bordered by fire-resistant material on three sides and extends away from the closing surface (E).

9. Smoke and/or fire protection curtain according to claim 1 wherein the wicket door, when in the slip position, has a clearance height (h) of at least 70 centimeters.

10. Smoke and/or fire protection curtain according to claim 1 wherein
(a) the wicket door comprises
a left lateral section,
a right lateral section and
a folding section,
(b) the left and right lateral sections are folded and extend along a closing surface (E), and
(c) the left and right lateral sections are fixed to an area of the protective element that does not form the wicket door, and wherein the at least one magnetic strip includes a plurality of magnetic strips, and wherein the left and right lateral sections are fixed at a distance from their lower wicket door edge by means of the plurality of magnetic strips.

11. Smoke and/or fire protection curtain according to claim 1 wherein
the wicket door is configured such that a lower wicket door edge is positioned at a same height as a body edge of the protective element.

12. Building, comprising
a wall which has an opening, and
a smoke and/or fire protection curtain according to claim 1, wherein the smoke and/or fire protection curtain is arranged at the opening in the wall for the reversible sealing of the opening.

13. Smoke and/or fire protection curtain according to claim 4 wherein the counter element is a ferromagnetic strip.
